(19) United States
(12) Patent Application Publication
(10) Pub. No.: US 2026/0166997 A1
(43) Pub. Date: Jun. 18, 2026

(54) IN VEHICLE INFOTAINMENT SYSTEM, METHOD OF CONTROLLING

(71) Applicants: Hyundai Motor Company, Seoul (KR); Kia Corporation, Seoul (KR)

(72) Inventors: Ik Jae Kwon, Hwaseong-si (KR); Ki Hye Jang, Hwaseong-si (KR); Sang Yeon Lim, Hwaseong-si (KR); Jin Young Park, Gimhae-si (KR)

(21) Appl. No.: 19/329,930

(22) Filed: Sep. 16, 2025

(30) Foreign Application Priority Data
Dec. 16, 2024 (KR) 10-2024-0186875

(51) Int. Cl. B60K 35/28; B60K 35/22; B60W 30/14; B60W 50/08; B60W 50/14; G06F 3/16

(52) U.S. Cl. CPC B60K 35/28; B60K 35/22; B60W 30/143; B60W 50/085; B60W 50/14; G06F 3/167; B60K 2360/128; B60K 2360/148; B60K 2360/164; B60K 2360/186; B60K 2360/741; B60W 2050/146; B60W 2540/22; B60W 2540/227

(57) ABSTRACT

In an embodiment an in-vehicle infotainment system includes one or more processors and a memory configured to store one or more programs executed by the one or more processors, wherein the processor is configured to calculate a visible distance of a driver and to change a displayed configuration of an interface to the in-vehicle infotainment system based at least in part on the calculated visible distance of the driver and a restriction.

### CROSS-REFERENCE TO RELATED APPLICATIONS

This application claims the benefit of and priority to Korean Patent Application No. 10-2024-0186875, filed on Dec. 16, 2024, the disclosure of which is incorporated herein by reference in its entirety.

### TECHNICAL FIELD

An in-vehicle infotainment system, and more specifically, an in-vehicle infotainment system that adjusts a way of using infotainment according to a visible distance.

### BACKGROUND

Most drivers experience extreme stress and fatigue when a visible distance is severely limited due to abnormal climate such as localized heavy rain or thick fog. In such situations, concentration is greatly required and the state of tension continues, increasing mental and physical burdens on the driver. A limited visible distance not only causes slow decision-making but also increases driving anxiety of a driver by increasing the likelihood of accidents.

One of the methods for securing a visible distance is a technique of using a camera. That is, conventionally, a surrounding environment of the vehicle is monitored in real time with the camera, and the monitoring results are intuitively provided to the driver.

Recently, many vehicles are equipped with an infotainment system, and the infotainment system provides services related to entertainment and is also used for vehicle control (e.g., opening or closing windows, turning lights on or off, etc.).

However, despite the increasing utilization of the infotainment system, a way of operating the infotainment system according to a visible distance is the same, and thus drivers who are not familiar with driving or operating the infotainment system have a lot of difficulties to operate the infotainment system in situations where a visible distance is not secured.

### SUMMARY

Embodiments provide an in-vehicle infotainment system that adjusts a way of using infotainment depending on a visible distance to ensure safe driving in conditions where a visible distance is not secured, a method of controlling the same, and a vehicle.

The technical problems intended to be achieved by the embodiments are not limited to the technical problems mentioned above, and other technical problems that are not mentioned will be clearly understood by a person having ordinary skill in the technical field to which the embodiments belong from the description below.

Disclosed embodiments provide an in-vehicle infotainment system including one or more processors and a memory configured to store one or more programs executed by the one or more processors, in which the processor calculates a visible distance of a driver while driving, and changes a way of using the infotainment system based on the calculated visible distance of the driver. Note in the specification and claims that follow, the phrase “visible distance of the driver”, and variations thereof, may be intended to broadly encompass determining a distance a driver can see, that is, the driver is able to see a certain distance. It will be appreciated the distance may be determined by one or more machines or sensors in a vehicle, and the determination may be used to control, direct, or otherwise affect operation of machines and/or sensors associated with a vehicle. The following includes several example applications of determining the visible distance.

The processor may restrict use of functions other than a driving-related function among a plurality of functions provided by the infotainment system when the calculated visible distance of the driver is less than or equal to a first distance.

The processor may change a way of operation to enable operation of the driving-related function based on voice recognition.

When a screen currently being displayed by the infotainment system is a route guidance screen, the processor may maintain the route guidance screen and guide that the use of functions other than the driving-related function is restricted when a function other than the driving-related function is requested from the driver.

The processor may automatically switch a screen currently being displayed by the infotainment system to a route guidance screen when the screen currently being displayed by the infotainment system is a screen other than the route guidance screen.

The processor may change a way of operating the infotainment system to enable operation of the infotainment system based on voice recognition when the calculated visible distance of the driver is greater than a first distance and less than or equal to a second distance.

The processor may guide that one of a plurality of functions provided by the infotainment system is selectable by the voice recognition when the one of the plurality of functions is selected by the ways of operating the infotainment system other than the voice recognition, and provide a function corresponding to a voice command of the driver recognized when the voice command is recognized.

The processor may increase sizes of buttons for operating a plurality of functions provided by the infotainment system and display the buttons when the calculated visible distance of the driver is greater than a second distance and less than or equal to a third distance.

The processor may perform processing so that at least one of automatic turning on of an emergency light of a vehicle, recommendation to reduce driving speed thereof, and automatic operation of an air conditioning system thereof is performed according to the calculated visible distance of the driver.

The processor may determine a weather surrounding a vehicle being driven, determine a degree of driving tension of the driver, and calculate the visible distance of the driver based on the weather surrounding the vehicle and the degree of driving tension of the driver. Note in the specification and claims that follow, the term “surrounding” and similar enclosing language may be intended to include partial surrounding, adjacency, or proximity, and it may not to be interpreted as requiring a complete surrounding. Thus, weather surrounding a vehicle includes weather proximate to and/or in some way affecting the vehicle (or the driver).

Disclosed embodiments provide a method of controlling an in-vehicle infotainment system including one or more processors and a memory configured to store one or more programs executed by the one or more processors, the method including calculating a visible distance of a driver while driving, and changing a way of using the infotainment system based on the calculated visible distance of the driver.

In the changing of the way, use of functions other than a driving-related function among a plurality of functions provided by the infotainment system may be restricted when the calculated visible distance of the driver is less than or equal to a first distance. Note that in the specification and claims that follow, the phrase “changing a way”, “change a way”, or the like, may be intended to generally refer to adjusting and/or altering operation of devices, components, machines, etc. associated with a vehicle; for example, changing a display of an infotainment system based at least in part on the calculated visible distance of the driver

In the changing of the way, a way of operation may be changed to enable operation of the driving-related function based on voice recognition.

The method may further include, after the changing of the way, when a screen currently being displayed by the infotainment system is a route guidance screen, maintaining the route guidance screen and guiding that the use of functions other than the driving-related function is restricted when a function other than the driving-related function is requested from the driver.

In the changing of the way, a screen currently being displayed by the infotainment system may be automatically switched to a route guidance screen when the screen currently being displayed by the infotainment system is a screen other than the route guidance screen.

In the changing of the way, a way of operating the infotainment system may be changed to enable operation of the infotainment system based on voice recognition when the calculated visible distance of the driver is greater than a first distance and less than or equal to a second distance.

The method may further include, after the changing of the way, guiding that one of a plurality of functions provided by the infotainment system is selectable by the voice recognition when the one of the plurality of functions is selected by the ways of operating the infotainment system other than the voice recognition, and providing a function corresponding to a voice command of the driver recognized when the voice command is recognized.

In the changing of the way, sizes of buttons for operating a plurality of functions provided by the infotainment system may be increased and the buttons are displayed when the calculated visible distance of the driver is greater than a second distance and less than or equal to a third distance.

The method may further include, after the changing of the way, performing processing so that at least one of automatic turning on of an emergency light of a vehicle, recommendation to reduce driving speed thereof, and automatic operation of an air conditioning system thereof is performed according to the calculated visible distance of the driver.

The calculating may further include determining a weather surrounding a vehicle being driven, determining a degree of driving tension of the driver, and calculating the visible distance of the driver based on the weather surrounding the vehicle and the degree of driving tension of the driver.

Disclosed embodiments provide a vehicle, which includes one or more processors and a memory configured to store one or more programs executed by the one or more processors, including an in-vehicle infotainment system that calculates a visible distance of a driver while driving, and changes a way of using the infotainment system based on the calculated or determined visible distance of the driver.

### BRIEF DESCRIPTION OF THE DRAWINGS

The above and other embodiments, features and advantages of the present disclosure will become more apparent to those of ordinary skill in the art by describing exemplary embodiments thereof in detail with reference to the accompanying drawings, in which:

FIG. 1 is a diagram illustrating a vehicle according to an embodiment of the present disclosure;

FIG. 2 is a block diagram illustrating an infotainment system according to an embodiment of the present disclosure;

FIGS. 3A and 3B are exemplary diagrams of screens displayed in a mode in which the use of functions other than driving-related functions is restricted;

FIGS. 4A and 4B are exemplary diagrams of screens displayed in a voice recognition mode;

FIGS. 5A and 5B are exemplary diagrams of screens displayed in an enlarged display mode;

FIGS. 6A to 6D are exemplary diagrams showing a way of setting a destination and guiding a driver to the destination according to the visible distance of the driver;

FIGS. 7A to 7D are exemplary diagrams showing a way of changing a sound source being played according to the visible distance of the driver; and

FIGS. 8 and 9 are flowcharts showing a method of controlling an in-vehicle infotainment system according to an embodiment of the present disclosure.

### DETAILED DESCRIPTION OF ILLUSTRATIVE EMBODIMENTS

Hereinafter, embodiments of the present disclosure will be described in detail with reference to the accompanying drawings so that those skilled in the art may easily carry out the embodiments. However, the present disclosure may be implemented in various different forms and is not limited to the embodiments described herein.

In describing embodiments of the present disclosure, when it is determined that a specific description of a known configuration or function may obscure the gist of the present disclosure, a detailed description thereof will be omitted. In addition, parts unrelated to the description of the present disclosure in the drawings have been omitted, and similar parts have been given similar reference numerals.

In the present disclosure, when a component is said to be “connected,” “coupled,” or “joined” to another component, this may include not only a direct connection relationship, but also an indirect connection relationship in which another component exists therebetween. In addition, when a component is referred to as “including” or “having” another component, this means that the component does not exclude the other component but may further include another component unless specifically stated to the contrary.

In this disclosure, the terms first, second, etc., are used only for the purpose of distinguishing one component from another component, and do not limit the order or importance of the components unless specifically stated otherwise. Therefore, within the scope of this disclosure, a first component in one embodiment may be referred to as a second component in another embodiment, and similarly, a second component in one embodiment may be referred to as a first component in another embodiment.

In this disclosure, components that are distinguished from each other are intended to clearly describe the characteristics of each component, and do not necessarily mean that the components are separated. That is, a plurality of components may be integrated to form a single hardware or software unit, or a single component may be distributed to form a plurality of hardware or software units. Accordingly, even if not mentioned separately, embodiments in which a plurality of components are integrated or a single component is distributed is also included in the scope of the present disclosure.

In this disclosure, the components described in various embodiments do not necessarily mean essential components, and some components may be optional components. Therefore, an embodiment composed of a subset of components described in an embodiment is also included in the scope of this disclosure. In addition, embodiments that include other components in addition to the components described in the various embodiments are also included in the scope of the present disclosure.

In the present disclosure, each of phrases such as “A or B,” “at least one of A and B,” “at least one of A or B,” “A, B or C,” “at least one of A, B and C,” and “at least one of A, B, C or combination thereof” may include any one of the items listed together with the corresponding phrase among the phrases, or all possible combinations thereof.

The advantages and features of the present disclosure, and the methods for achieving them will become clearer with reference to the embodiments described in detail below together with the accompanying drawings. However, the present disclosure is not limited to embodiments presented below, but may be implemented in various different forms, and the embodiments are provided only to make the disclosure of the present disclosure complete and to fully inform a person having ordinary skill in the art to which the present disclosure belongs of the scope of the disclosure.

In addition, the terms “module,” “unit,” “device,” “server,” etc., in this specification may also be intended to refer to hardware or a functional or structural combination of software driven by or for driving hardware. For example, the hardware herein may be a data processing device including a central processing unit (CPU) or another first processor. In addition, the software driven by the hardware may refer to a process, an object, an executable, a thread of execution, a program, etc., that are being executed.

Hereinafter, the specific technical contents to be implemented in the present disclosure will be described in detail with reference to the accompanying drawings.

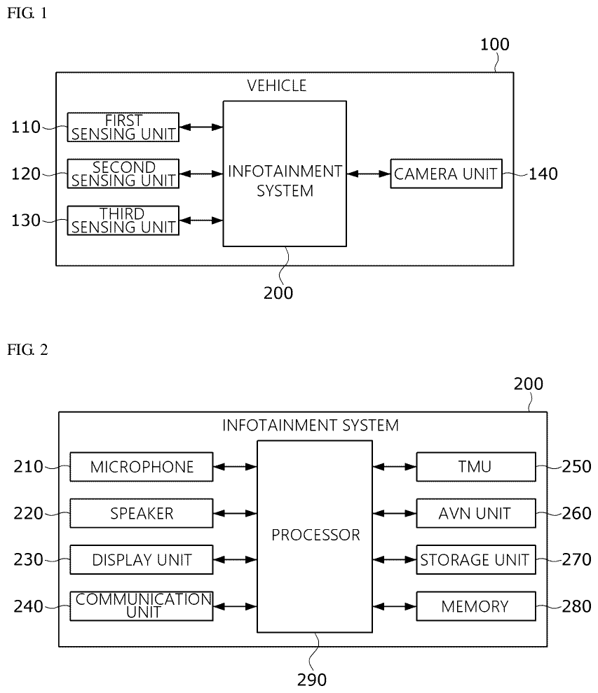

FIG. 1 is a diagram illustrating a vehicle 100 according to an embodiment of the present disclosure.

Referring to FIG. 1, the vehicle 100 according to the embodiment of the present disclosure may include a first sensing unit 110, a second sensing unit 120, a third sensing unit 130, a camera unit 140, and an infotainment system 200.

The first sensing unit 110 may detect or otherwise determine information related to the weather of a location where the vehicle 100 is driving and transmit the detected information to the infotainment system 200. The first sensing unit 110 may include a rain sensor, an outdoor temperature sensor, a fog sensor, a humidity sensor, and a light amount sensor. For example, the rain sensor may be provided on a windshield to detect an amount of rainfall. The outdoor temperature sensor detects the temperature outside the vehicle 100. The fog sensor detects outdoor fog and can measure a visible distance. The humidity sensor detects the humidity inside and outside the vehicle. The light amount sensor measures the intensity of light to detect cloudy weather or dark environments. Note in the specification and claims that follow, use of the term “detect” (and variations thereof, e.g., detects, detecting, etc.) may be intended to broadly encompass determining something corresponding to the detection, e.g., determining characteristics of weather, temperature, humidity, levels, status, associated data, etc.

The second sensing unit 120 may or otherwise determine detect information related to biometric information of a user and transmit the detected information to the infotainment system 200. The second sensing unit 120 may include a galvanic skin response (GSR) sensor and a pupil sensor. The GSR sensor detects skin conductance amplitude of the user. The pupil sensor periodically detects a change amount of the pupil diameter of the driver. The user may be the driver or a passenger.

The third sensing unit 130 may track the eyes of the user and transmit information on the tracked eyes to the infotainment system 200. The third sensing unit 130 tracks the eyes of the user using an eye tracking sensor.

One or more camera units 140 are provided at the front, side, or rear of the vehicle 100 to capture images of at least a portion of the environment surrounding the vehicle. For example, a camera provided at the front may capture a forward view in a driving direction to obtain a forward view image and transmit the obtained forward view image to the infotainment system 200.

The infotainment system 200 is a system that provides information provision and an entertainment function in an integrated manner. For example, the infotainment system 200 provides various functions such as a navigation function, media playback, smartphone linkage, driver assistance, and vehicle state monitoring. In addition, the infotainment system may provide various services in conjunction with the first sensing unit 110, the second sensing unit 120, the camera unit 140, and other controllers in the vehicle 100.

The navigation function provides destination search and route guidance and provides real-time traffic information. The media playback provides streaming music or video and provides radio or game play. The smartphone linkage provides phone calls, text message transmission and reception, and execution of apps installed on a smartphone, etc., by using smartphone mirroring. The driver assistance function recognizes a voice command of the driver (e.g., opening or closing windows, turning an air conditioner on or off, turning a light on or off, etc.) and allows an action corresponding to the voice command to be performed. The vehicle state monitoring performs a lane departure warning, a collision warning, etc., and provides vehicle state information.

FIG. 2 is a block diagram illustrating the infotainment system 200 according to an embodiment of the present disclosure.

Referring to FIG. 2, the infotainment system 200 according to the embodiment of the present disclosure may include a microphone 210, a speaker 220, a display unit 230, a communication unit 240, a telematics unit (TMU) 250, an audio/video/navigation (AVN) unit 260, a storage unit 270, a memory 280, and a processor 290.

The microphone 210 receives an external sound signal (e.g., a voice command of the driver, call contents, etc.) and converts the sound signal into electrical audio data. The microphone 210 can remove noise generated in the process of receiving the sound signal.

The speaker 220 outputs audio related to functions of the infotainment system 200 (e.g., music, information search results, etc.) to the outside.

The display unit 230 may include a display panel that displays a screen related to the functions of the infotainment system 200 and a touch panel that receives an operation command from the driver through a touch sensor. The touch panel may be configured to convert changes in pressure applied to a specific location of the display panel or electrostatic capacity occurring at a specific part into an electrical input signal.

The communication unit 240 may include one or more components that enable communication between components inside the vehicle or communication between components of the vehicle 100 and external devices, and may include, for example, at least one of a short-range communication module, a wired communication module, and a wireless communication module.

The external devices may include a server supporting various control, state management, and driving or connected car services of the vehicle 100, an intelligent transportation system (ITS) device for receiving information from the ITS, a user terminal registered in the vehicle 100, and another vehicle communicating in a Vehicle to Vehicle (V2V) scheme.

The short-range communication module may include various short-range communication modules that transmit and receive signals using a wireless communication network in a short range, such as a Bluetooth module, an infrared communication module, a radio frequency identification (RFID) communication module, a wireless local access network (WLAN) communication module, a near field communication (NFC) module, and a ZigBee communication module.

The wired communication module may include various wired communication modules such as a local area network (LAN) module, a wide area network (WAN) module, or a value added network (VAN) module, as well as various cable communication modules such as a universal serial bus (USB), high definition multimedia interface (HDMI), digital visual interface (DVI), recommended standard 232 (RS-232), power line communication, or plain old telephone service (POTS).

The wired communication module may further support controller area network (CAN) communication or local interconnect network (LIN) communication.

The wireless communication module may include a wireless communication module that supports various wireless communication methods, such as a WiFi module, a wireless broadband module, a global system for mobile communication (GSM) module, a code division multiple access (CDMA) module, a wideband code division multiple access (WCDMA) module, a universal mobile telecommunications system (UMTS) module, a time division multiple access (TDMA) module, a long term evolution (LTE) module, and an ultra-wide band (UWB) module.

The TMU 250 may receive multimedia data and transmit the multimedia data to the AVN unit 260. The multimedia data includes streaming data.

The AVN unit 260 may play multimedia data received from the TMU 250 or stored in the AVN unit 260. The AVN unit 260 may be a system that integrates a multimedia playback device and a navigation device.

The storage unit 270 may store information related to weather detected by the first sensing unit 110 (hereinafter referred to as “weather signal”), information related to the driver's body detected by the second sensing unit 120 (hereinafter referred to as “biometric signal”), eye tracking information detected by the third sensing unit 130, and a forward view image acquired and/or otherwise received by the camera unit 140.

The memory 280 stores at least one program (e.g., an operating system, software, firmware, middleware, or applications, etc.), various types of data, and at least one command for controlling the vehicle 100, and the program may be loaded thereinto, data may be read or record therefrom or thereto, an operation corresponding to the command may be performed using the data stored therein at the request of the processor 290. The memory 280 may include a volatile memory and a nonvolatile memory.

The processor 290 may perform overall control of the vehicle 100 according to an input command. The command may be input to the memory 280 or the communication unit 240 by the processor 290. The processor 290 may control the operation of other components (hardware or software) connected to the vehicle 100 by executing a program or command stored in the memory 280 and may perform data processing and computation. In addition, the processor 290 may load commands or data received from other components into the volatile memory, process the commands or data stored in the volatile memory, and store the processing results in the nonvolatile memory.

The processor 290 may calculate the visible distance of the driver driving the vehicle, e.g. the distance the driver is able to see, and change the way of using the infotainment system 200 based on the calculated visible distance of the driver. In addition, the processor 290 may perform processing so that at least one of automatic turning on of the emergency light of the vehicle, recommendation to reduce the driving speed thereof, and automatic operation of the air conditioning system thereof is performed according to the calculated visible distance of the driver.

In detail, the processor 290 may determine at least a portion of the surrounding weather of the vehicle 100 being driven from the detected weather signal. The weather signal may include an amount of rainfall, an amount of fog, the visible distance of the vehicle 100, the humidity inside the vehicle, the humidity outside the vehicle, a degree of cloudiness of the weather, etc. The visible distance of the vehicle 100 is calculated by a set algorithm and may be the same as or different from a visible distance of the driver.

In addition, the processor 290 may determine the degree of driving tension of the driver from the detected biometric signal and eye tracking information. The biometric signal may include a change amount of the GSR amplitude and pupil diameter of the driver. The processor 290 may determine, for example, that the greater the change amount of the GSR amplitude, the greater the change amount of the pupil diameter, and the greater the change amount of the eyes, the higher the degree of driving tension.

In addition, the processor 290 may calculate the visible distance of the driver based on the determined surrounding weather and degree of driving tension. The visible distance of the driver may be determined as one of four previously categorized sections. The four sections are sections corresponding to the first section, which is 50 m or less, the second section, which is greater than 50 m and less than or equal to 100 m, the third section, which is greater than 100 m and less than or equal to 200 m, the fourth section, which is greater than 200 m. In addition, an example where a first distance is 50 m, a second distance is 100 m, and a third distance is 200 m will be described. The number of sections described above, the number corresponding to the range of each section, and the numbers determined for the first to third distances are examples and may be changed.

For example, when the visible distance of the vehicle 100 included in a detected weather signal is 50 m, the processor 290 may determine the actual visible distance, i.e., the visible distance of the driver, as the second section (greater than 50 m and less than or equal to 100 m) when the degree of driving tension of the driver is less than or equal to a first criterion, and may determine the visible distance of the driver as the first section (less than or equal to 50 m) when the degree of driving tension is greater than the first criterion. In addition, when the visible distance of the vehicle is 120 m, the processor 290 may determine the visible distance of the driver as the second section (greater than 50 m and less than or equal to 100 m) when the degree of driving tension of the driver is higher than the first criterion, and determine the visible distance of the driver as the second section when it is higher than the first criterion. The first criterion may be lower than the second criterion.

When the calculated visible distance of the driver is less than or equal to the first distance, that is, less than or equal to 50 m, the processor 290 may switch to a use restriction mode and perform processing to restrict the use of functions other than driving-related functions among a plurality of functions provided by the infotainment system 200. Driving-related functions include, for example, destination setting, destination change, driving speed adjustment, vehicle status monitoring, and display.

In addition, when the visible distance of the driver is less than or equal to the first distance, the processor 290 may change a way of operating the infotainment system to enable operation of a driving-related function based on voice recognition. Since the use of functions other than the driving-related functions is restricted, the processor 290 may only perform voice commands for the driving-related function among the voice commands input from the driver.

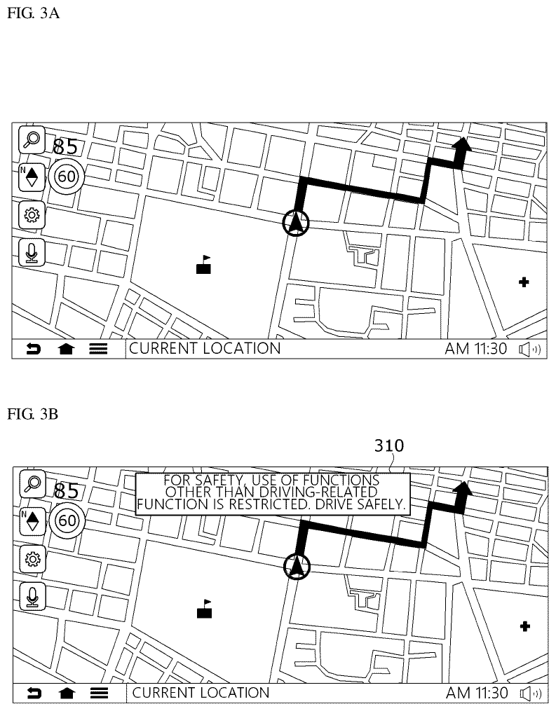

In addition, when the visible distance of the driver is less than or equal to the first distance, the processor 290 may generate a first message 310 that guides that the use of functions other than the driving-related functions is restricted and display the first message 310 on the route guidance screen when the screen currently being displayed by the infotainment system 200 is a route guidance screen as shown in FIG. 3A.

Alternatively, when the visible distance of the driver is less than or equal to the first distance, the processor 290 may maintain the route guidance screen as shown in FIG. 3B, generate a first message 310 guiding that the use of functions other than the driving-related function is restricted, and display the first message 310 on the route guidance screen when a function other than a driving-related function is requested from the driver when the screen currently being displayed by the infotainment system 200 is a route guidance screen as shown in FIG. 3A.

In addition, when the visible distance of the driver is less than or equal to the first distance, the processor 290 may automatically switch a screen currently being displayed by the infotainment system 200 from a multimedia playback screen to the route guidance screen when the screen currently being displayed by the infotainment system 200 is a screen other than the route guidance screen (e.g., a multimedia playback screen, a search screen, etc.).

In addition, when the visible distance of the driver is less than or equal to the first distance, the processor 290 may calculate a maximum speed for safety driving obtained by applying a deceleration rate to the speed limit of a road on which the vehicle 100 is driving and provide guidance through voice or message, perform processing so that an air conditioning system operates for automatic humidity control, and perform processing so that the emergency light is turned on. The speed limit on the road on which the vehicle is driving may be known through the global positioning system (GPS) and the navigation device, and the deceleration rate may be a rate prescribed by road laws depending on a visible distance.

For example, the processor 290 may command a climate control unit (CCU) or a heating, ventilation, and air conditioning electronic control unit (HVAC ECU) to perform Auto Defog. In addition, the processor 290 may command an advanced driver assistance systems (ADAS) controller or a body control module (BCM) to turn the emergency light on.

Meanwhile, when the calculated visible distance of the driver is greater than the first distance and less than or equal to the second distance, that is, greater than 50 m and less than or equal to 100 m, the processor 290 may switch to a voice recognition mode and change the way of operating the infotainment system 200 to enable operation of the infotainment system 200 based on voice recognition. The driver may use all the functions provided by the infotainment system 200 but may use the functions only through voice commands.

In addition, when the visible distance of the driver is greater than the first distance and less than or equal to the second distance, the processor 290 may generate a second message 410 guiding that one of the plurality of functions provided by the infotainment system is selectable by voice recognition and display the second message 410 on the screen when one of the plurality of functions provided by the infotainment system is selected by the ways of operating the infotainment system other than voice recognition (e.g., touching a menu on the screen). When the voice command of the driver is recognized, the processor 290 provides a function corresponding to the recognized voice command.

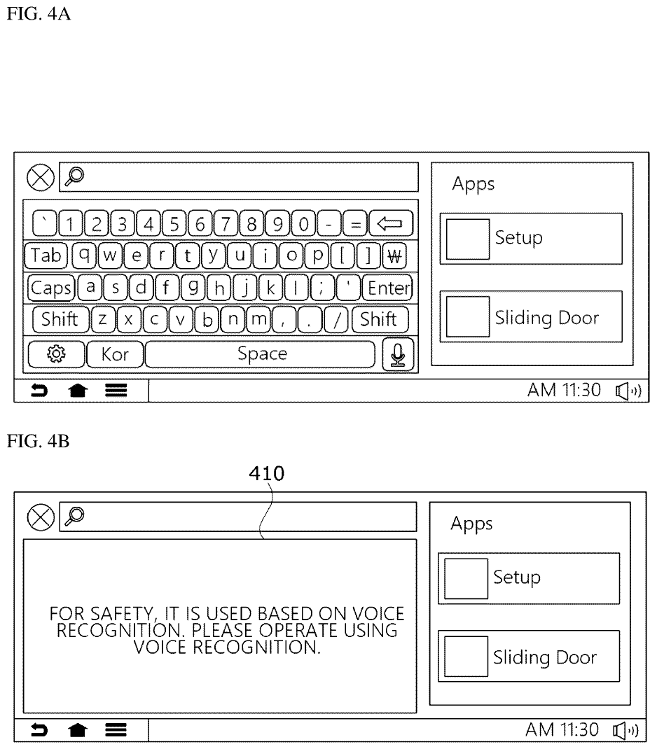

FIGS. 4A and 4B are exemplary diagrams of screens on which the second message 410 is displayed.

Conventionally, as shown in FIG. 4A, regardless of the visible distance of the driver, a keypad search screen is displayed when the driver touches a search menu on the screen.

However, since the visible distance of the driver corresponds to the second section, the processor 290 may generate the second message 410 guiding that selection is possible through voice recognition as shown in FIG. 4B instead of the keypad search screen and displays the second message 410 on the display unit 230. When the calculated visible distance of the driver is greater than the first distance and less than or equal to the second distance, the processor 290 may generate and display the second message 410 as shown in FIG. 4B, or when the driver touches the display unit 230 to select a menu, the processor 290 may generate and display the second message 410.

In addition, when the visible distance of the driver is greater than the first distance and less than or equal to the second distance, the processor 290 may calculate and guide a maximum speed for safety driving obtained by applying a deceleration rate to the speed limit of the road on which the vehicle 100 is traveling, and performs processing so that the air conditioning system is operated for automatic humidity control.

Meanwhile, when the calculated visible distance of the driver is greater than the second distance and less than or equal to the third distance, that is, greater than 100 m and less than or equal to 200 m, the processor 290 may switch to an enlarged display mode, increase the sizes of buttons for operating a plurality of functions provided by the infotainment system 200, and display the buttons.

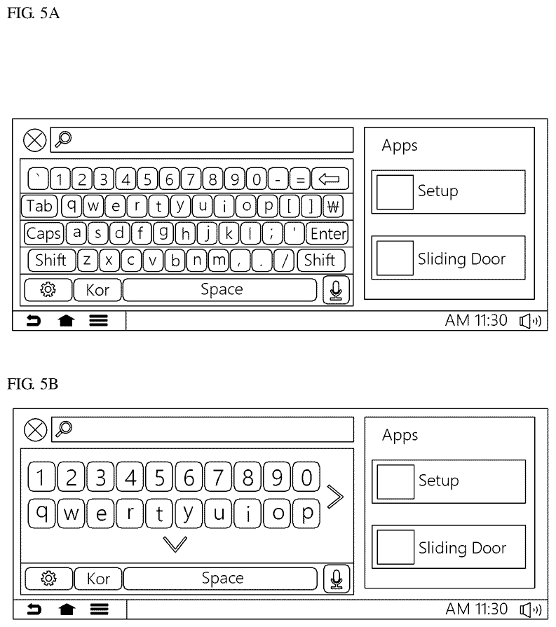

FIGS. 5A and 5B are exemplary diagrams showing an enlarged and displayed keypad.

FIG. 5A illustrates the size of a keypad search screen or keypad displayed in a normal driving situation. When the visible distance of the driver becomes shorter than in the normal driving situation and corresponds to the third section, the processor 290 may enlarge and display the keypad as in FIG. 5B when the driver touches a search menu on the screen.

In addition, when the visible distance of the driver is greater than the second distance and less than or equal to the third distance, the processor 290 may perform processing so that the air conditioning system is operated for automatic humidity control.

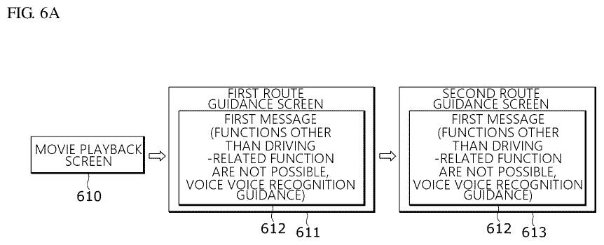

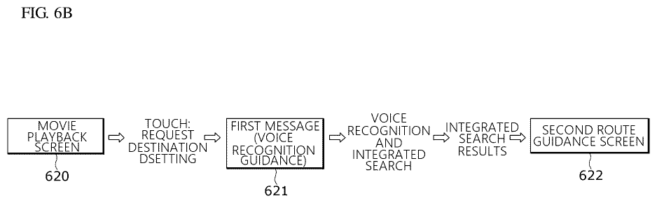

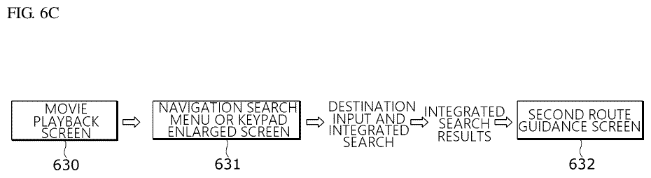

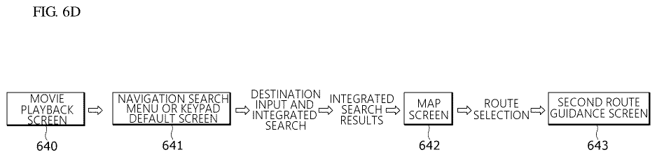

FIG. 6A to FIG. 6D are exemplary diagrams showing a way of setting a destination and guiding a driver to the destination according to the visible distance of the driver.

Referring to FIG. 6A, the display unit 230 is displaying a movie playback screen 610. When it is determined that the current visible distance of the driver is within 50 m, the processor 290 ends the movie playback screen 610 or displays a first route guidance screen 611. The first route guidance screen 611 may be a screen in which the destination is set, or, may be a screen showing at least a portion of the surroundings of the current location when the destination is not set. When the driver utters the destination by voice, the processor 290 displays a second route guidance screen 613 that guides to the destination corresponding to the recognized voice of the user. The first route guidance screen 611 and the second route guidance screen 613 are restricted for use of the functions other than the driving-related function and display a first message 612 guiding that the infotainment system operates based on voice recognition on the screen.

Referring to FIG. 6B, the display unit 230 is displaying the movie playback screen 620. When it is determined that the current visible distance of the driver is greater than 50 m and less than or equal to 100 m, the processor 290 changes the settings to enable the operation of the system 200 based on voice recognition. That is, the processor 290 switches to the voice recognition mode. When the driver touches a menu displayed on the display unit 230 or movie playback screen 620 and requests destination setting, the processor 290 guides that only voice commands are possible through voice or the first message 621. When the driver utters the destination by voice, the processor 290 performs an integrated search for the destination corresponding to the recognized voice of the user and displays a second route guidance screen 622 showing the integrated search results.

Referring to FIG. 6C, the display unit 230 is displaying a movie playback screen 630. When the driver touches the menu displayed on the display unit 230 or movie playback screen 630 and requests destination setting, the processor 290 enlarges and displays a navigation search menu or keypad 631 when it is determined that the current visible distance of the user is greater than 100 m and less than or equal to 200 m. When the driver inputs a destination through the enlarged menu or keypad 631, the processor 290 performs the integrated search for the input destination and displays a second route guidance screen 622 showing the integrated search result.

Referring to FIG. 6D, the display unit 230 is displaying a movie playback screen 640. When the driver touches the menu displayed on the display unit 230 or movie playback screen 640 and requests destination setting, the processor 290 enables the destination to be set in a way of being provided in a basic mode when the current visible distance of the driver exceeds 200 m. That is, the processor 290 displays a navigation search menu or keypad 641 with a size set as a default. When the driver inputs a destination, the processor 290 performs an integrated search for the input destination and displays the integrated search results and a map screen 642. When the driver selects a route on the map screen 642, the processor 290 displays a second route guidance screen 643 that provides route guidance along the selected route.

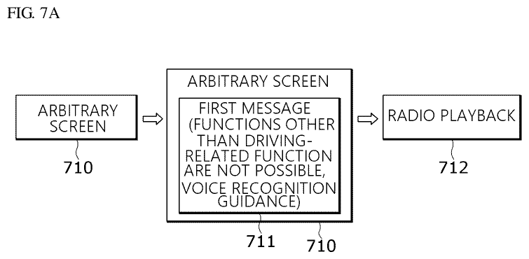

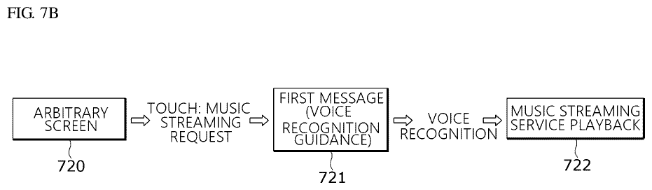

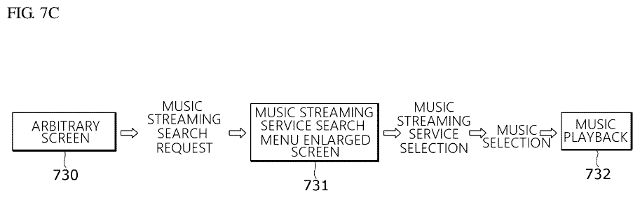

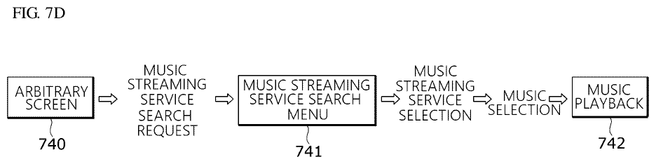

FIGS. 7A to 7D are exemplary diagrams showing a way of changing a sound source being played according to the visible distance of the driver.

Referring to FIG. 7A, the processor 290 is outputting radio to the speaker 220 while displaying an arbitrary screen 710 on the display unit 230. The arbitrary screen 710 may display a video related to the radio being played, an information screen, or no information. When the driver selects a menu on the arbitrary screen 710 and requests to change the sound source to a music streaming service, the processor 290 guides that infotainment cannot be used for functions other than the driving-related function and therefore cannot change the sound source (711) when it is determined that the current visible distance of the driver is within 50 m, and continues playing the radio (712).

Referring to FIG. 7B, the display unit 230 is displaying an arbitrary screen 720. When it is determined that the current visible distance of the driver is greater than 50 m and less than or equal to 100 m, the processor 290 changes the settings to enable operation of the system 200 based on voice recognition. When the driver touches a menu displayed on the arbitrary screen 720 and requests to change the sound source to a music streaming service, the processor 290 provides guidance through the voice or first message 721 that only a voice command is possible. When the driver utters a desired music streaming service (for example, Melon, YouTube Music, etc.) or a music title by voice, the processor 290 plays the music streaming service or music corresponding to the voice of the driver (722).

Referring to FIG. 7C, the display unit 230 is displaying an arbitrary screen 730. When the driver touches a menu displayed on the screen 730 and requests a music streaming service search, the processor 290 enlarges and displays the music streaming service search menu (or the selection button) when it is determined that the current visible distance of the driver is greater than 100 m and less than or equal to 200 m (731). When the driver selects the desired streaming service and desired music through the enlarged and displayed search menu or selection button, the processor 290 plays the selected music 732.

Referring to FIG. 7D, the display unit 230 is displaying an arbitrary screen 740. When the driver touches a menu displayed on the screen 740 and requests a search for a music streaming service, the processor 290 enables the sound source to be changed in the way of being provided in the basic mode when the current visible distance of the driver is greater than 200 m. That is, the processor 290 displays a music streaming service search menu (or a selection button) with a size set as a default 741. When the desired streaming service and desired music are selected, the processor 290 plays the selected music 742.

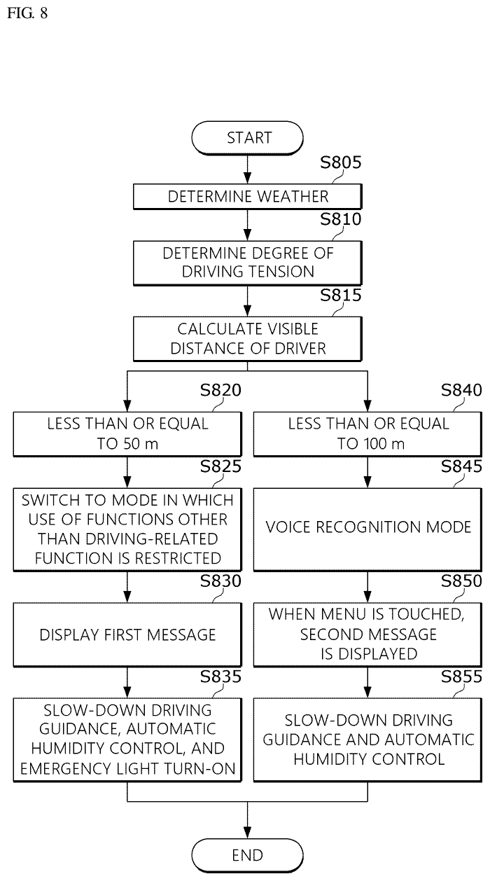

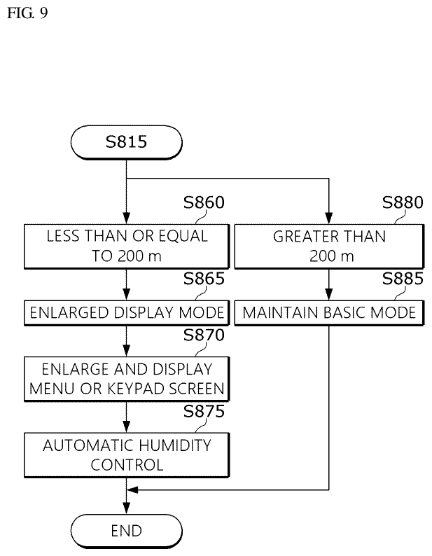

FIGS. 8 and 9 are flowcharts illustrating a method of controlling the in-vehicle infotainment system 200 according to an embodiment of the present disclosure.

Referring to FIGS. 8 and 9, the processor 290 of the in-vehicle infotainment system 200 may determine the weather surrounding the vehicle 100 from a weather signal detected by the first sensing unit 110 (S805). The weather signal may include an amount of rainfall, an amount of fog, a visible distance of the vehicle 100, humidity inside the vehicle, humidity outside the vehicle, a degree of cloudiness of the weather, etc.

The processor 290 may determine a degree of driving tension of the driver from a biometric signal detected by the second sensing unit 120 and eye tracking information detected by the third sensing unit 130 (S810). The biometric signal may include the change amount of the GSR amplitude and pupil diameter of the driver.

The processor 290 may calculate the visible distance of the driver based on the determined surrounding weather and degree of driving tension (S815). The visible distance of the driver may be divided into sections corresponding to, for example, the first section, which is 50 m or less, the second section, which is greater than 50 m and less than or equal to 100 m, the third section, which is greater than 100 m and less than or equal to 200 m, the fourth section, which is greater than 200 m. Therefore, even when a visible distance of the vehicle 100 is, for example, 80 m, the visible distance of the driver may be calculated to be less than or equal to 50 m, maintained to less than or equal to 100 m, or calculated to be greater than 100 m depending on the degree of driving tension.

When the calculated visible distance of the driver is less than or equal to the first distance (e.g., less than or equal to 50 m) (S820), the processor 290 switches to a mode in which the use of functions other than the driving-related function is restricted (S825). That is, the processor 290 may perform processing so that the use of functions other than the driving-related functions among the plurality of functions provided by the infotainment system 200 is restricted, and change the way of operating the infotainment system 200 to enable the operation of the driving-related function based on voice recognition.

In addition, when the visible distance of the driver is less than or equal to the first distance, the processor 290 may generate the first message 310 that guides that the use of functions other than the driving-related function is restricted on the screen currently being displayed on the display unit 230 and display the first message 310 on the route guidance screen as shown in FIG. 3B (S830).

In addition, when the visible distance of the driver is less than or equal to the first distance, the processor 290 may calculate and provide guidance on the maximum speed for safety driving, performs processing so that the air conditioning system is operated for automatic humidity control, and performs processing so that the emergency light is turned on (S835).

On the other hand, when the calculated visible distance of the driver is greater than the first distance and less than or equal to the second distance (e.g., when it is greater than 50 m and less than or equal to 100 m) (S840), the processor 290 may change the way of operating the infotainment system 200 to enable operation of the infotainment system 200 based on voice recognition (S845). That is, the processor 290 switches to a voice recognition mode, and the driver can use all functions provided by the infotainment system 200 but can only use the functions through voice commands.

When one of the plurality of functions provided by the infotainment system 200 is selected by the ways of operating the infotainment system 200 other than voice recognition (e.g., touching the menu on the screen), the processor 290 may generate the second message 410 guiding that the function can be selected by voice recognition and display the second message 410 as shown in FIG. 4B (S850).

The processor 290 may calculate and guide the maximum speed for safety driving obtained by applying the deceleration rate to a speed limit of a road on which the vehicle 100 is driving and performs processing so that the air conditioning system is operated for automatic humidity control (S855).

Meanwhile, when the calculated visible distance of the driver is greater than the second distance and less than or equal to the third distance (e.g., when it is greater than 100 m and less than or equal to 200 m) (S860), the processor 290 may switch to an enlarged display mode (S865), increase the sizes of the buttons for operating the plurality of functions provided by the infotainment system 200 on the screen currently being displayed, and display the buttons (S870).

When the driver selects a search button (S870), a keypad displayed on the search screen may also be enlarged and displayed (S875).

In addition, the processor 290 may perform processing so that the air conditioning system is operated for automatic humidity control (S880).

Meanwhile, when the calculated visible distance of the driver is greater than the third distance (e.g., when it exceeds 200 m), the processor 290 operates in the basic mode without being changed to a mode in which the use of functions other than driving-related function provided by the infotainment system 200 is restricted (S885).

According to the present disclosure, when the degree of driving tension of the driver increases due to abnormal climate such as fog, a visible distance is calculated by considering the degree of driving tension, and the way of using infotainment is adjusted according to the calculated visible distance of the driver, thereby enabling safe driving in conditions where a visible distance is not secured.

In addition, according to the present disclosure, the infotainment system can automatically adjust functions to help a driver drive safely so as to achieve contextual awareness, thereby enabling safe driving and also reducing the risk of accidents.

The effects that can be obtained from the present disclosure are not limited to the effects mentioned above, and other effects that are not mentioned can be clearly understood by a person having ordinary knowledge in the technical field to which the present disclosure belongs from the description below.

Various embodiments of the present disclosure do not list all possible combinations but are intended to explain representative embodiments of the present disclosure, and the matters described in the various embodiments may be applied independently or in a combination of two or more.

In addition, various embodiments of the present disclosure may be implemented by hardware, firmware, software, or a combination thereof. In the case of hardware implementation, the present disclosure may be implemented using one or more application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, etc.

The scope of the present disclosure includes software or machine-executable instructions (e.g., operating systems, applications, firmware, programs, etc.) that cause operations according to the methods of the various embodiments to be executed on a device or a computer, and a non-transitory computer-readable medium in which such software or instructions are stored and executed on the device or the computer.

What is claimed is:

1. An in-vehicle infotainment system comprising:
one or more processors; and
a memory configured to store one or more programs executed by the one or more processors,
wherein the processor is configured to:
calculate a visible distance of a driver; and
change a displayed configuration of an interface to the in-vehicle infotainment system based at least in part on the calculated visible distance of the driver and a restriction.

2. The in-vehicle infotainment system of claim 1,
wherein the in-vehicle infotainment system is configured to provide a plurality of functions,
wherein the processor is configured to restrict the plurality of functions to use of driving-related functions, and
wherein the restriction is based at least in part on the calculated visible distance of the driver being less than or equal to a first distance.

3. The in-vehicle infotainment system of claim 2, wherein the processor is configured to change operation of the in-vehicle infotainment system to enable operation of the driving-related function based at least in part on voice recognition.

4. The in-vehicle infotainment system of claim 2, wherein, based at least in part on a screen currently being displayed by the in-vehicle infotainment system is a route guidance screen, the processor is configured to maintain the route guidance screen and guides that the use of functions other than the driving-related function is restricted based at least in part on a function other than the driving-related function is requested from the driver.

5. The in-vehicle infotainment system of claim 2, wherein the processor is configured to automatically switch a screen currently being displayed by the in-vehicle infotainment system to a route guidance screen based at least in part on the screen currently being displayed is a screen other than the route guidance screen.

6. The in-vehicle infotainment system of claim 1, wherein the processor is configured to change operation of the in-vehicle infotainment system to enable operation of the in-vehicle infotainment system based at least in part on voice recognition and the calculated visible distance of the driver is greater than a first distance and less than or equal to a second distance.

7. The in-vehicle infotainment system of claim 6, wherein the processor is configured to: guide that one of a plurality of functions provided by the in-vehicle infotainment system is selectable by the voice recognition based at least in part on the one of the plurality of functions being selected by operating the in-vehicle infotainment system other than the voice recognition; and
provide a function corresponding to a voice command of the driver recognized based at least in part on the voice command being recognized.

8. The in-vehicle infotainment system of claim 1, wherein the processor is configured to enlarge and display buttons associated with operating a plurality of functions provided by the in-vehicle infotainment system based at least in part on the calculated visible distance of the driver being greater than a second distance and less than or equal to a third distance.

9. The in-vehicle infotainment system of claim 1, wherein the processor is configured to perform controlling at least one of an automatic turning on of an emergency light of a vehicle, recommending to reduce driving speed, or automatic operating an air conditioning system according to the calculated visible distance of the driver.

10. The in-vehicle infotainment system of claim 1, wherein the processor is configured to: determine a weather adjacent a vehicle;
determine a degree of driving tension of the driver; and
calculate the visible distance of the driver based on the weather adjacent the vehicle and the degree of driving tension of the driver.

11. A method for controlling an in-vehicle infotainment system of a vehicle, wherein the in-vehicle infotainment system comprises one or more processors and a memory configured to store one or more programs executed by the one or more processors, the method comprising:
calculating a visible distance of a driver of the vehicle;
determining a restriction of use of functions of the in-vehicle infotainment system; and
changing a displayed configuration of an interface to the in-vehicle infotainment system based at least in part on the calculated visible distance of the driver and the restriction.

12. The method of claim 11,
wherein the in-vehicle infotainment system provides a plurality of functions,
wherein the restriction at least restricts the plurality of functions to use of driving-related functions, and
wherein the restriction is based at least in part on the calculated visible distance of the driver being less than or equal to a first distance.

13. The method of claim 12, wherein, in changing an operation of the in-vehicle infotainment system includes enabling an operation of the driving-related function based at least in part on voice recognition.

14. The method of claim 12, further comprising:
after changing the displayed configuration, based at least in part on a screen currently being displayed by the in-vehicle infotainment system is a route guidance screen, maintaining the route guidance screen and guiding that the use of functions other than the driving-related function is restricted based at least in part on a function other than the driving-related function is requested from the driver.

15. The method of claim 12, wherein, in changing the displayed configuration, a screen currently being displayed by the in-vehicle infotainment system is automatically switched to a route guidance screen based at least in part on the screen currently being displayed by the in-vehicle infotainment system is a screen other than the route guidance screen.

16. The method of claim 11, wherein, in changing the displayed configuration, an operation of the in-vehicle infotainment system is changed to enable operation of the in-vehicle infotainment system based on voice recognition based at least in part on the calculated visible distance of the driver is greater than a first distance and less than or equal to a second distance.

17. The method of claim 16, further comprising:
after the changing the displayed configuration, guiding that one of a plurality of functions provided by the in-vehicle infotainment system is selectable by the voice recognition based at least in part on the one of the plurality of functions is selected by operation of the in-vehicle infotainment system other than the voice recognition; and
providing a function corresponding to a voice command of the driver recognized based at least in part on the voice command is recognized.

18. The method of claim 11, wherein, in changing the displayed configuration, sizes of buttons associated with operating a plurality of functions provided by the in-vehicle infotainment system is increased and the buttons are displayed based at least in part on the calculated visible distance of the driver is greater than a second distance and less than or equal to a third distance.

19. The method of claim 11, further comprising, after changing the displayed configuration, performing processing so that at least one of automatic turning on of an emergency light of a vehicle, recommendation to reduce driving speed thereof, and automatic operation of an air conditioning system thereof is performed according to the calculated visible distance of the driver.

20. The method of claim 11, wherein calculating further comprises:
determining a weather adjacent a vehicle being driven;
determining a degree of driving tension of the driver; and
calculating the visible distance of the driver based on the weather adjacent the vehicle and the degree of driving tension of the driver.
